(19) United States
(12) Patent Application Publication
(10) Pub. No.: US 2016/0272755 A1
(43) Pub. Date: Sep. 22, 2016

(54) POLYESTER POLYMER AND METHOD FOR MANUFACTURING THE SAME

(71) Applicant: LIANG HAW TECHNOLOGY CO., LTD., TAIPEI CITY (TW)

(72) Inventors: LI-CHUN YU, TAIPEI CITY (TW); FANG-JUEI CHOU, TAIPEI CITY (TW); CHUN-YUNG YU, TAIPEI CITY (TW); YU-WEN CHENG, TAIPEI CITY (TW); YU-CHOU CHAO, TAIPEI CITY (TW); SHANG-MING LIN, TAICHUNG CITY (TW); HAN-HSING HSIUNG, TAIPEI CITY (TW)

(21) Appl. No.: 14/793,898

(22) Filed: Jul. 8, 2015

(30) Foreign Application Priority Data
Mar. 16, 2015 (TW) 104108256

(51) Int. Cl. C08G 63/91

(52) U.S. Cl. CPC C08G 63/916

(57) ABSTRACT

A polyester polymer and a method for manufacturing the same are revealed. Sulfonate groups (—SO₃) are used for modification of polyethylene terephthalate (PET) and chemical extrusion technique is used in modification processes. The physiochemical properties of PET sulfonate obtained including moisture absorption, secondary transition temperature, melting point etc. are improved significantly. Thus the dyeing process can be carried out at lower temperature and the dyeing depth is improved. The purpose of energy saving and reduced carbon dioxide emission are further achieved.

### FIELD OF THE INVENTION

The present invention relates to polyester polymer and a method for manufacturing the same, especially to a polyethylene terephthalate (PET) and a method for manufacturing the same. The PET is modified into PET with branched-chain sulfonates by chemical extrusion technique.

### BACKGROUND OF THE INVENTION

Polyethylene terephthalate (PET) is cream or pale-yellow liquid crystal polymer with smooth and shiny surface obtained by polycondensation of diol with diacid. PET is a kind of engineering plastic with good performance and wide applications. In our daily life, most of clothes, bedding and household goods includes polyester made from PET.

Due to hydrophobicity of PET, the clothes made from PET have poor water-absorbency so that users feel hot and sticky. This is one of the disadvantages. Moreover, the hydrophobicity also causes higher difficulty in dyeing. In a vat of dyes, high temperature and high pressure are required for diffusion of dyes into clothes fiber. As a result, a lot of energy is consumed.

Thus a plurality of methods has been developed and invented in order to modify PET. However, most of the methods are based on polymerization. In consideration of the effects of reaction conditions such as temperature, reactant concentration and catalyst concentration, etc, the polymerization involves a number of complicated steps. During mass production, the processing waste produced causes pollution problems.

### SUMMARY

Therefore it is a primary object of the present invention to provide a polyester polymer that includes sulfonate groups in structure and having lower melting point and lower secondary transition temperature than polyethylene terephthalate (PET) not modified. Moreover, the modified polyester polymer has higher moisture absorption. This is beneficial to reduction of energy consumed during dyeing process and the wearing comfort of the fabric made of polyester polymer is enhanced. As to the physical properties of the fabric such as elongation rate, they will not be changed.

It is another object of the present invention to provide a method for manufacturing a polyester polymer in which sulfonate groups are connected to PET in a staggered manner by chemical reaction and extrusion to form PET sulfonate. The modified PET manufactured by the method overcomes shortcomings of PET and has the same advantages. Moreover, different from general polymerization way, the present method can be carried out in a lot size or in a small amount and the cost is low.

In order to achieve the above objects, a polyester polymer of the present invention is PET sulfonate with a general formula:

H-A₁-A₂-A₃- . . . Aₙ-OH

wherein A₁˜Aₙ is selected from the group consisting of

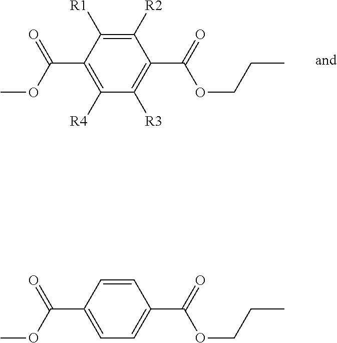

wherein one of R1, R2, R3 and R4 is a sulfonate group while the rest three groups are hydrogen groups respectively; n is smaller than 10000; A₁˜Aₙ include at least one

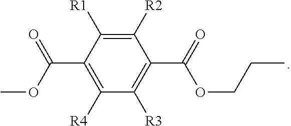

A method for manufacturing polyester polymer mentioned above according to the present invention includes following steps. First, a polyethylene terephthalate (PET) is melted in an extruder. Then, a sulfonate is added into the melted PET to form a mixture of PET with the sulfonate. Next, PET is modified into PET sulfonate by sulfonation in the extruder.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart showing steps of an embodiment according to the present invention;

FIG. 2 is a schematic drawing showing an extruder in use of an embodiment according to the present invention;

FIG. 3 is a Fourier Transform Infrared (FT-IR) spectrum of sodium polyethylene terephthalate sulfonate manufactured by an embodiment according to the present invention.

### DETAILED DESCRIPTION

Please refer to figures and embodiments of the present invention so as to learn features and functions of the present invention.

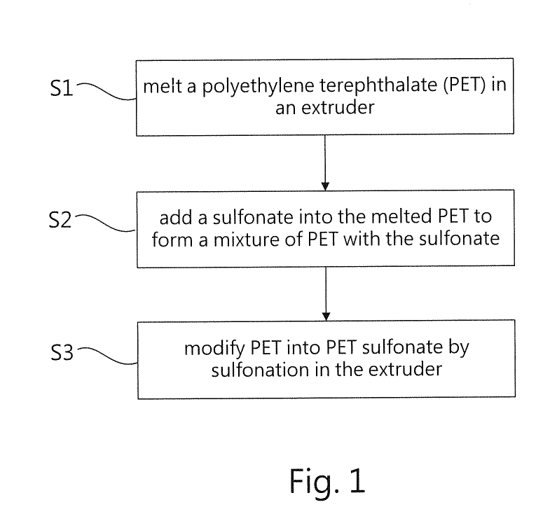

Refer to FIG. 1, a method of the present invention modifies polyethylene terephthalate (PET) by chemical extrusion technique. Thus the modified PET includes sulfonate groups. A method for manufacturing modified PET includes following steps.

Step S1: melt a polyethylene terephthalate (PET) in an extruder;
Step S2: add a sulfonate into the melted PET to form a mixture of PET with the sulfonate; and
Step S3: modify PET into PET sulfonate by sulfonation in the extruder.

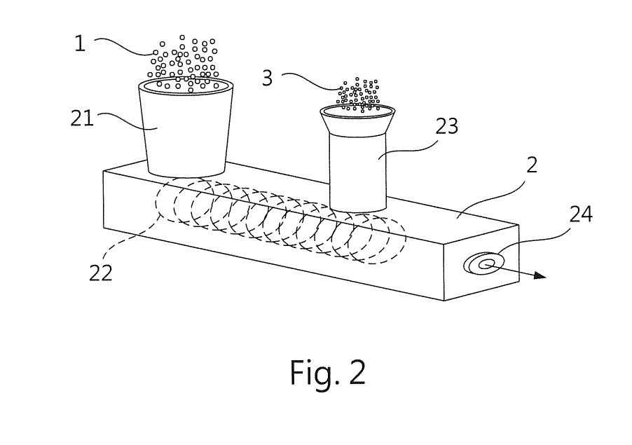

Refer to FIG. 2, a schematic drawing showing an extruder is revealed. As shown in figure, polyester raw material 1, supplied as solid granules, is poured into a first material inlet 21 of an extruder 2. The polyester raw material 1 is polyethylene terephthalate (PET) whose chemical structure is as following:

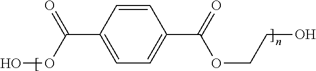

wherein n is smaller than 100000. The melting point of PET is about 260° C. A heating unit 22 of the extruder 2 provides thermal energy to melt solid granules of PET into liquid flowing in the extruder 2.

Besides the first material inlet 21, the extruder 2 includes a second material inlet 23 used to feed raw materials for modification. In an embodiment of the present invention, a sulfonate 3 used for modification is sodium dodecyl sulfonate (SDS) with a chemical structure of:

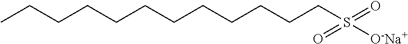

Sulfonate groups provided by SDS are attached to PET in a staggered manner by sulfonation for modification of PET. The monomer units of PET include glycol moiety and dicarboxylic acid moiety, having a chemical structure of:

H-A-G-A-G-A-G-A-G-A-G-OH

wherein A is dicarboxylic acid moiety and G is glycol moiety. The sulfonate groups used in the present invention only bond to A, without G. This is a modification form in which bondings are arranged in a staggered manner. The modification process occurs in the extruder 2 and then solid products are output through a discharge outlet 24 of the extruder 2.

In an embodiment of the present invention, the mole ratio of PET to sulfonate (SDS) is about 100:1. The sulfonate group is reacted to the polymerization part of PET for modification. The sulfonate group is connected to the benzene ring of PET in various forms by ionic bonding. These forms are shown in the following structural formula 1-4.

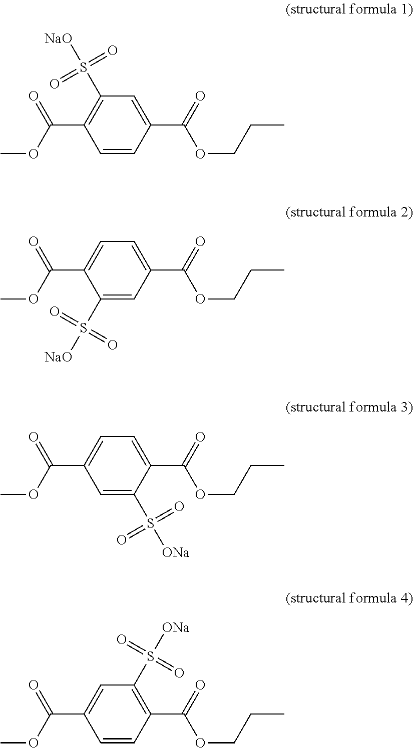

According to the above various forms, the polymer manufactured by the method of the present invention has following general formula:

H-A₁-A₂-A₃- . . . Aₙ-OH

wherein A₁˜Aₙ is selected from the group consisting of

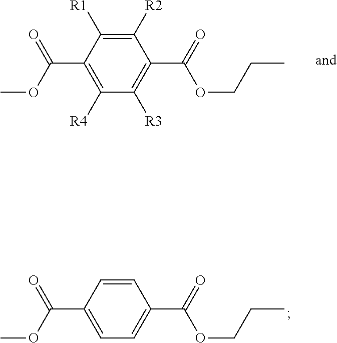

wherein one of R1, R2, R3 and R4 is a sulfonate group while the rest three groups are hydrogen groups respectively; n is smaller than 10000; A₁˜Aₙ include at least one

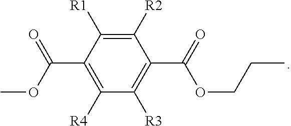

In other words, some repeating units include no sulfonate group and the benzene ring therein is not modified.

After being modified into PET sulfonate, the structure of the principle chain is not closely-packed as easily as before due to sulfonate on the branched chain. Thus the melting point is decreased from 260° C. before modification to 210˜220° C. or even lower after modification. No matter being modified or not, PET can be used as raw material for manufacturing chemical fiber fabric. The PET sulfonate with lower melting point has more advantages during manufacturing processes. For example, lower-temperature dyeing process improves energy efficiency and reduces carbon dioxide emission.

Moreover, the secondary/glass Transition Temperature (Tg) of the modified polymer is also decreased. The glass transition temperature relates to the ability of polymer molecules to move around (shapeability is also changed). The chemical fiber fabric with lowered glass transition temperature has higher softness and flexibility. Moreover, processes of dyeing and finishing engineering including pretreatment of the fabric, dyeing the fabric with dyes and after-treatment of the dyed fabric can be performed at lower temperature.

Besides lowers the melting point and the glass transition temperature caused by structure change, the sulfonate group in PET sulfonate also improves water absorbency. The sulfonate group is hydrophilic so that the modified polymer has better water absorbency. The property of the chemical fiber fabric is improved. Please refer to the following table, the comparison of water absorbency of different polymers is shown.

TABLE 1

| | Relative | Moisture |
|---|---|---|
| material | Humidity | Regain |
| polyethylene terephthalate (PET) | 65% | 0.4% |
| sodium polyethylene terephthalate | 65% | 2.0% |
| sulfonate | | |
| sodium polyethylene terephthalate | 95% | 3.5% |
| sulfonate | | |

Take PET modified by SDS as an example. The sample under test is set in a constant temperature chamber at 20° C. for 24 hours and the result is shown in the above table one. When a relative humidity in the constant temperature chamber is 65%, the modified polymer has higher moisture regain. Moisture regain is defined as the percentage of water present in a textile material of oven dry weight. The moisture regain is an indicator showing moisture absorption of the fabric. The manufacturing processes of chemical fiber fabric include the dyeing process and the dye is an aqueous solution. Thus sodium PET sulfonate with better moisture absorption allows more dye molecules to attach and dyeing depth is thus improved. The high temperature and high pressure in a vat of dyes for diffusion of dyes into the fabric PET without modification requires is no more needed. Thus the dyeing difficulty and energy consumed during manufacturing processes are both reduced. The wearing comfort of the cloth made from the chemical fiber is enhanced due to higher moisture absorption. At the same time, the cloth is less likely to cause a static charge.

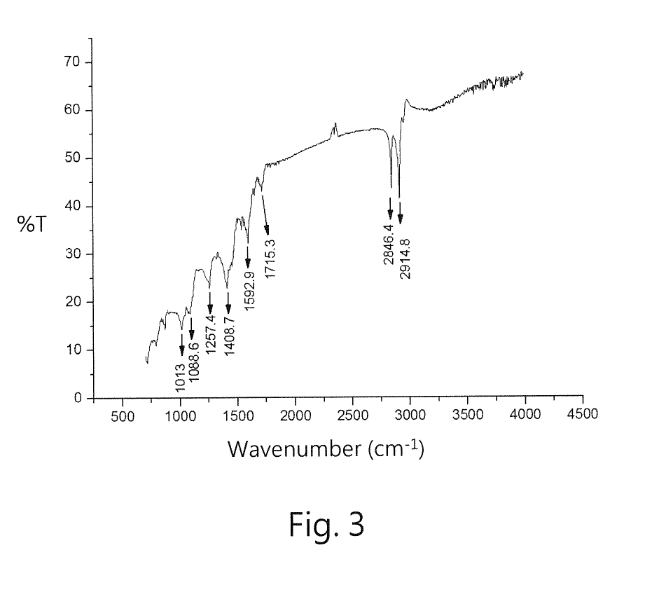

Refer to FIG. 3, a Fourier Transform Infrared spectrum of sodium polyethylene terephthalate sulfonate after modification is revealed. A peak at 1000˜1150 cm⁻¹ corresponding to the sulfonate group has been learned. The absorption peaks found at 1013 cm⁻¹ and 1088.6 cm⁻¹ in the figure are characteristic peaks showing the resonance conditions in the sulfonate groups. The existence of the sulfonate groups has been proved. That means the PET has been modified into sulfonated PET.

In summary, a polyester polymer and a method for manufacturing the same of the present invention use sulfonate groups for modification of PET and chemical extrusion technique is used in the modification process. The physiochemical properties of PET sulfonate obtained including moisture absorption, secondary transition temperature, melting point etc. are all improved significantly. Thus the dyeing process can be carried out at lower temperature and the dyeing depth is improved. The energy efficiency is further improved and carbon dioxide emission is reduced. Moreover, clothes made of PET sulfonate have better water absorbency and softness. Thus the polyester polymer and the method for manufacturing the same of the present invention are of great value on both the manufacturer's end and on the sales market.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A polyester polymer that is polyethylene terephthalate sulfonate comprising a formula of: H-Aₙ-OH wherein n is larger than 2 and smaller than 10000, and A is selected from the group consisting of 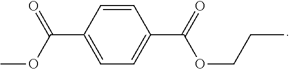 [SMILES: CCCOC(=O)c1ccc(C(=O)OC)cc1]
and at least one of A is replaced by 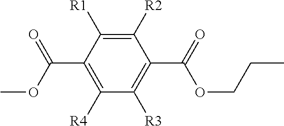
wherein one of R1, R2, R3 and R4 is a sulfonate group while the remaining three groups are hydrogen groups respectively.

2. The polymer as claimed in claim 1, wherein the polyethylene terephthalate sulfonate is sodium polyethylene terephthalate sulfonate.

3. The polymer as claimed in claim 2, wherein a melting point of the sodium polyethylene terephthalate sulfonate is lower than 220 degrees Celsius (° C.).

4-6. (canceled)
